(19) United States
(12) Patent Application Publication
(10) Pub. No.: US 2017/0145837 A1
(43) Pub. Date: May 25, 2017

(54) METHOD OF MAKING A BLADED ROTOR FOR A TURBOMACHINE

(71) Applicant: MTU Aero Engines AG, Munich (DE)

(72) Inventors: Martin SCHLOFFER, Munich (DE); Wilfried SMARSLY, Munich (DE)

(21) Appl. No.: 15/351,797

(22) Filed: Nov. 15, 2016

(30) Foreign Application Priority Data
Nov. 19, 2015 (EP) 15195403.9

(51) Int. Cl. F01D 5/30

(52) U.S. Cl. CPC F01D 5/3061; F05D 2220/323; F05D 2230/236; F05D 2230/31; F05D 2230/40; F05D 2300/174; F05D 2230/239; F05D 2230/42

(57) ABSTRACT

A method of making a bladed rotor for a turbomachine, in particular for an aircraft engine, is disclosed. The method comprises the steps a) providing a rotor base of the rotor, b) providing at least one blade root, c) providing at least one blade body, d) making at least one blade by connecting the blade body to the blade root by means of a diffusion barrier layer, at least the blade body, the diffusion barrier layer and the blade root consisting of respectively different materials, and e) joining the at least one blade root to the rotor base. The invention furthermore relates to a bladed rotor and to a turbomachine having such a bladed rotor.

### CROSS-REFERENCE TO RELATED APPLICATIONS

The present application claims priority under 35 U.S.C. §119 of European Patent Application No. 15195403.9, filed Nov. 19, 2015, the entire disclosure of which is expressly incorporated by reference herein.

### BACKGROUND OF THE INVENTION

1. Field of the Invention

The invention relates to a method of making a bladed rotor for a turbomachine, in particular for an aircraft engine. The invention furthermore relates to a bladed rotor for a turbomachine and to a turbomachine having such a rotor.

2. Discussion of Background Information

From the prior art, it is known to make bladed rotors by milling from solid material, which is very elaborate and expensive, for which reason this method has found use only for relatively small gas turbine rotors. Such rotors having integral blading for turbomachines such as gas turbines or aircraft engines are referred to, depending on whether there is a rotor or rotor carrier (referred to below as the rotor base) which is disk-shaped in cross section or is ring-shaped in cross section, as blisk or bling for brevity. Blisk is an abbreviation of “bladed disk”, while bling is an abbreviated form of “bladed ring”. Another method, which is employed for large rotors, is friction welding. In this case, the rotor base and the blades are produced separately and subsequently friction-welded to one another. With this method, however, it is only possible to join together similar, and above all fusion-weldable materials. For example, it is not however possible to use brittle or non-fusion-weldable alloys as material for the blades.

For the connection of blades, it is known as an alternative to insert their blade roots into corresponding sockets in the rotor base. This, however, is likewise very elaborate and, because of the requirement for ductility of the blade root, entails considerable compromises in respect of the selection of the materials and the configuration of the blade body of the blade.

It would be advantageous to have available a method of making a bladed rotor for a turbomachine which allows a more flexible material selection for the rotor base and the blade body of at least one blade. It would also he advantageous to have available a bladed rotor in which the materials of the rotor base and at least of a blade body of at least one blade can be selected more flexibly. It would furthermore be advantageous to have available a turbomachine having such a bladed rotor.

### SUMMARY OF THE INVENTION

The present invention provides a method, a bladed rotor and a turbomachine according to the present independent claims. Advantageous configurations having expedient refinements of the invention are specified in the respective dependent claims, and advantageous configurations of each aspect of the invention are to be regarded as advantageous configurations of the other respective aspects of the invention, and vice versa.

A first aspect of the invention relates to a method of making a bladed rotor for a turbomachine, in particular for an aircraft engine. According to the invention, the method comprises the steps a) providing a rotor base of the rotor, b) providing at least one blade root, c) providing at least one blade body, d) making at least one blade by connecting the blade body to the blade root by means of a diffusion barrier layer, at least the blade body, the diffusion barrier layer and the blade root consisting of respectively different materials, and e) joining the at least one blade root to the rotor base. In other words, according to the invention, the bladed rotor is produced as a material composite from at least three different materials, by first producing one or more blades respectively from a blade root, a mediating diffusion barrier layer and a blade body, the blade root, the diffusion barrier layer and the blade body of each blade respectively consisting of different materials. Subsequently, the blade root of this blade is joined to the rotor base. This allows particularly high flexibility in the selection of the materials for the rotor base, or the blade root and the blade body, since the blade body may be made not only from a ductile alloy, but also from a brittle alloy, and be optimized in terms of its creep properties, which it has not previously been possible to achieve because of the minimum ductility requirements. The diffusion barrier layer ensures that intermetallic phases possibly occurring between the blade body and the diffusion barrier layer or diffusion limiting layer exerts no influence, or at least no substantial influence on the ductility of the blade overall. Furthermore, the diffusion barrier layer can be optimized for any desired material combinations of the blade root or the rotor base and the blade body, without the chemical compositions and mechanical properties of the blade root or of the rotor base and of the blade body influencing one another or being modified. Accordingly, respectively different microstructures can be formed in all the parts, i.e. in the rotor base, in the blade root, in the diffusion barrier layer and in the blade body. The rotor can therefore be produced in a way which is particularly flexible and optimized for the respective intended use. The person skilled in the art will realize that the sequence of the steps a) to e) need not thoroughly be carried out in the order described, and that alternative step sequences, for example c), b), a), d) and e), are also possible.

In one advantageous configuration of the invention, in step a), a rotor base made of a nickel-based alloy, in particular of DA 718, IN 718, AD 730, Waspaloy or Udimet 720, and/or of a titanium alloy, in particular of Ti64, Ti6242, Ti6246 or Ti834, is provided, these having outstanding properties for use as a disk material or ring material. A nickel-based alloy is intended to mean any alloy, particular an alloy which is stable at high temperatures, which contains nickel as the main constituent. Correspondingly, a titanium alloy is intended to mean any alloy which contains titanium as the main constituent.

In another advantageous configuration of the invention, in step b), a blade root is provided which at least in the region of its surface consists of the same material, or a material of the same type, as the rotor base. A material of the same type is in this case intended to mean materials which may in principle be substitutable one another and can be processed in the same way. If the rotor base consists of a nickel-based alloy such as DA 718, for example, the blade root may consist of DA 718 as well, or of IN 718, AD 730, Waspaloy or Udimet 720, or may have at least one surface made of the aforementioned materials. Similar considerations apply for other alloys. Preferably, both the blade root and the rotor base comprise materials that can be welded to one another, so that a complex socket connection may advantageously be obviated. Provision may be made that the blade root consists entirely of the same material or a comparable material as the rotor base. As an alternative, provision may be made that the same material or the comparable material, of which the rotor base, is applied additively optically or by friction welding onto the blade root, the core of which may therefore consist of a different material. As an alternative or in addition, provision is made that the upper side of the blade root is arranged in the lowest-load region of the future blade. In other words, provision is made that the connection zone between the blade body and the blade root is provided in the region of the largest cross-sectional area of the blade, since it is here that the lowest local stresses occur and a correspondingly high strength is ensured. Correspondingly, the diffusion barrier layer is also arranged in that region of blade which is subjected to the least stresses during operation of the bladed rotor. This allows particularly high flexibility in the material selection for the rotor base and the blade body, since any occurrence of intermetallic phases in the region of the diffusion barrier layer exerts no effects, or no substantial effects, on the properties of the blade overall.

In another advantageous configuration of the invention, in step e) the blade root is joined to the rotor base with a material fit, and is in particular welded to the rotor base. This way, the rotor base and the blade root are joined in such a way that they can be mechanically loaded significantly.

In another advantageous configuration of the invention, it is provided that the blade body is constructed additive optically on the barrier layer in step c), and/or before step d) the diffusion barrier layer is constructed additive optically on the blade root and/or connected to the blade root by friction welding. Suitable as additive production methods are, in particular, selective laser melting, selective laser sintering, electron-beam melting and/or laser deposition welding. These additive or generative production methods on the one hand allow a high degree of freedom in terms of the selection of the material or materials, and on the other hand they also offer great freedom in the geometrical configuration, so that complexly shaped surfaces and internal structures of the blade body can also be constructed. Likewise, a geometrically complexly configured blade root can also be provided simply and precisely with the diffusion barrier layer. Furthermore, provision may be made that the diffusion barrier layer is connected to the blade root by friction welding. The formation of connection in the case of friction welding takes place essentially by diffusion processes in the interfaces between the two friction partners. The welding heat is generated by means of friction on the faces being joined. By intensive contact of the parts to be joined during the welding process, it is possible to connect materials with very different melting points and lattice structures, a very high strength being achieved with lower heat input compared with fusion welding methods.

In particular when the rotor base, the blade root and/or the blade body consist or consists of a TiAl alloy, or comprise such an alloy, it has furthermore been found advantageous for the diffusion barrier layer to be produced from a material compatible with a TiAl alloy, in particular from a CoTiAl alloy.

Further advantages are obtained by producing the diffusion barrier layer in step d) with a layer thickness of at least about 1 mm and/or with a layer thickness of at most about 50 mm. Although smaller thicknesses or layer thicknesses in the range of from 15 to 150 μm may also be envisioned in principle, layer thicknesses of at least about 1 mm have been found advantageous in order to ensure operationally reliable separation of the different materials. For example, average layer thicknesses in the range of 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, 10.0 mm or more may be provided. As an alternative or in addition, provision may be made that the layer thickness is at most 50 mm, i.e. for example 50 mm, 49 mm, 48 mm, 47 mm, 46 mm, 45 mm, 44 mm, 43 mm, 42 mm, 41 mm, 40 mm, 39 mm, 38 mm, 37 mm, 36 mm, 35 mm, 34 mm, 33 mm, 32 mm, 31 mm, 30 mm, 29 mm, 28 mm, 27 mm, 26 mm, 25 mm, 24 mm, 23 mm, 22 mm, 21 mm, 20 mm, 19 mm, 18 mm, 17 mm, 16 mm, 15 mm, 14 mm, 13 mm, 12 mm, 11 mm, 10 mm or less, in order to ensure a sufficiently strong connection between the blade root and the blade body.

According to another advantageous configuration of the invention the blade body is provided together with a root strip in step c). To this end, for example, a root strip may be constructed first and the blade body may be constructed subsequently. Conversely, it is also possible for the blade body to be constructed first, followed by the root strip. In this way, the finished rotor can be provided with a radially inner cover strip. in principle, provision may also be made that the blade body has a radially outer cover strip, or is formed with such a cover strip.

According to another advantageous figuration of the invention, a blade body made of a TiAl alloy, in particular a TiAl alloy which besides Ti and Al also comprises at least one element from the group W, Mo, Nb, Co, Hf, Y, Zr, Er, Gd, Si and C as a further alloy constituent, is provided in step c). In other words, a TiAl alloy, in particular a TiAl alloy which besides Ti and Al also comprises at least one element from the group W, Mo, Nb, Co, Hf, Y, Zr, Er, Gd, Si and C as a further alloy constituent, is used in order to construct or produce at least the blade body. Alloys which are stable at high temperatures can therefore be used for the blade body, without having to satisfy the ductility requirements for the mechanically connected blade root.

According to another advantageous configuration of the invention, at least the blade body is constructed in step c) by means of an additive production method, in particular by selective laser melting (SLM), selective laser sintering, electron-beam melting (EBM) and/or laser deposition welding (LMD), and/or by friction welding, and/or by hot isostatic pressing of a capsule filled with a material powder. Thus, for example, the blade body may be constructed by means of EBM and/or SLM in a vacuum in a powder bed directly on the diffusion barrier layer. As an alternative or in addition, a capsule may be applied conventionally by welding it on, filled with powder, evacuated, heated, welded and hot-isostatically pressed (HIP'ed). Likewise, provision may be made that a capsule is constructed “in situ” in an additive manufacturing apparatus on the diffusion barrier layer, filled with material powder and hot-isostatically pressed (HIP'ed). Furthermore, the blade body may be produced as a hollow blade and connected optionally in the already heat-treated state to the anti-diffusion diffusion barrier layer by friction welding. In this case, defined thin transition zones are achieved, which are preferably positioned by corresponding geometrical selection where the finally processed blade has the least loads, or the greatest cross-sectional area. In this way, intermetallic phases possibly occurring in the region of the diffusion barrier layer are noncritical in respect of their low ductility.

Further advantages are obtained by heat-treating the rotor base and/or the blade root and/or the diffusion barrier layer and/or the blade body individually or in any desired combination before and/or during and/or after step e). This allows particularly flexible adjustment of the mechanical and chemical properties as a function of the respective material pairings. In the context of the present invention, a heat treatment is intended to mean a method in which the workpiece in question is heated at least once to above room temperature and cooled again to room temperature at least once. It is likewise possible to carry out the precipitations in the blade body by anneals in the corresponding temperature range, before it is connected to the diffusion barrier layer. A heat treatment of the multilayer composite of the rotor base/blade root/diffusion barrier layer/(optional root strip)/blade body requires material-based matching of the transition temperatures in the individual material groups, in order to be able to heat-treat the composites (blade with layer and block) in a common oven anneal. When using TiAl alloys, this is possible for example by selection of the proportion of Al. The temperature range should in this case be selected in principle so that a homogeneous grain size distribution is set up, which ensures an optimal creep strength in the blade body and strength in the lower layer region, or at the junction with the rotor base.

A second aspect of the invention relates to a bladed rotor for a turbomachine, in particular for an aircraft engine, comprising a rotor base and at least one blade connected to the rotor base, the blade comprising in the radial direction at least a blade root joined to the rotor base, a diffusion barrier layer and a blade body, at least the blade body, the diffusion barrier layer and the rotor base respectively consisting of different materials. This allows a more flexible selection of the materials of the rotor base and at least of the blade body of at least one blade, so that for example brittle materials may also be provided for the blade body. Preferably, a plurality or all of the blades connected to the rotor base are configured in this way. Further features and advantages thereof may be found in the descriptions of the first aspect of the invention, and advantageous configurations of the first aspect of the invention are to be regarded as advantageous configurations of the second aspect of the invention, and vice versa. Preferably, the bladed rotor can be obtained and/or is obtained by a method according to the first aspect of the invention.

A third aspect of the invention relates to a turbomachine, in particular an aircraft engine, comprising at least one bladed rotor that can be obtained and/or is obtained by a method according to the first aspect of the invention, and/or is configured according to the second aspect of the invention. This allows a more flexible selection of the materials of the rotor base and at least of the blade body of at least one blade, so that for example brittle materials may also be provided for the blade body. Features resulting therefrom and the advantages thereof may be found in the descriptions of the first and second aspects of the invention, and advantageous configurations of the first and second aspect of the invention are to be regarded as advantageous configurations of the third aspect of the invention, and vice versa.

### DETAILED DESCRIPTION OF EMBODIMENTS OF THE INVENTION

Further features of the invention may be found in the claims and the exemplary embodiments. The features and feature combinations mentioned above in the description, as well as the features and feature combinations mentioned below in the exemplary embodiments and/or described individually may be used not only in the combination respectively indicated, but also in other combinations or in isolation, without departing from the scope of the invention. Embodiments of the invention which are not explicitly shown and explained in the exemplary embodiments, but which derive and may be produced by separate feature combinations from the embodiments explained, are also to be regarded as included and disclosed. Embodiments and feature combinations which therefore do not have all the features of an originally formulated independent claim are also to be regarded as disclosed.

The connection of brittle blades to a rotor base, which may for example be configured as a disk, by means of a mechanical connection technique has many problems in terms of the configuration and lifetime of this connection. In order to overcome this problem of mechanical connection, for example, blades made of a TiAl alloy are intended to be connected by welding to a disk consisting of a nickel-based alloy. In order not to detrimentally affect the chemical composition and properties of the disk, however, TiAl alloys cannot be welded directly onto the disk. According to the invention, therefore, a diffusion barrier layer is used as an intermediate layer, which constitutes a diffusion barrier to the disk and, for example, prevents TiAl alloy elements or intermediate layer alloy elements from diffusing into the disk. In this case, for example, the blade is provided directly below the root strip, i.e. at the largest cross section of the blade, with a TiAl-compatible anti-diffusion layer, which is a few millimeters thick. This diffusion harrier layer may, for example, be based on a CoTiAl alloy or consist of such an alloy.

A thicker block or blade root, which consists at least on the surface of the same material as or a comparable material to the rotor base, which acts as a connecting layer to the Ni base material of the rotor disk or of the rotor base and the blade root, is connected to this diffusion barrier layer. To this end, for example, material which is the same as or comparable to the material of the disk may be applied onto the blade root by additive manufacture or by friction welding. As an alternative, the entire blade root may be produced from the same material as or a comparable material to the rotor base. Because of the materials which are the same or comparable, detrimental chemical modifications do not occur in the rotor disk during welding. In contrast to the prior art, it is therefore also unnecessary for a brittle blade root to be anchored in the rotor disk by means of a socket connection, so that any problems in terms of the required ductility of the blade root are avoided. The block, or blade root, and the rotor base may, for example, consist of DA 718, IN 718 or AD 730. A titanium alloy, for example Ti64, Ti6242, Ti6246 or Ti834, may likewise be provided.

The block or blade bottom, which forms at least a part of the blade root of the blade, has a corresponding geometry in order that it can be fitted and welded into a corresponding recess of the rotor base, or of the disk. Preferably, the different properties in the defined connection zones are taken into account, and kept non-critical by corresponding geometrical configuration. The blade root may, for example, be trapezoidal or triangular in cross section, and fitted and welded into a corresponding recess the rotor base.

The blade body of the blade may, for example, be constructed additive optically on the diffusion barrier layer. The blade body may therefore be optimized in terms of its properties, for example its creep properties, which would no longer be possible in conventional blades because of the unfulfillable requirement for ductility of the blade root. In order to produce the blade body, it is therefore possible to use TiAl alloys possibly with high levels of one or more elements from the group W, Mo, Nb, Co, Hf, Y, Zr, Er, Gd, Si or C, without having to fulfil the ductility requirements for mechanically connected blade roots. By a corresponding heat treatment of the individual parts before connection, different microstructures, which fulfill the respectively required requirements, may he formed in all the components (blade body, diffusion barrier layer, blade root, disk).

As an alternative, it is possible to apply a TiAl-compatible anti-diffusion layer which is a few millimeters thick, for example made of an alloy containing CoTiAl, onto the upper side of the blade bottom or root by means of an additive method (for example SLM, EBM or LMD) or by friction welding. On this diffusion barrier layer, which is preferably arranged or formed in the lowest-load cross section of the blade in the lower bottom strip, the TiAl blade body may subsequently be constructed by various methods. Thus, for example, the blade body may be constructed directly on the diffusion barrier layer by means of EBM/SLM in a vacuum in a powder bed. A capsule may also be applied by welding it on, filled with powder, evacuated, heated, welded and HIP'ed. Likewise, a capsule may be constructed in situ in an EBM or SLM apparatus on the diffusion barrier layer, filled with powder, HIP'ed and correspondingly heat-treated. Furthermore, a blade body produced as a hollow TiAl blade and already heat-treated may be connected to the anti-diffusion diffusion barrier layer by friction welding. In this case, defined thin transition zones are achieved, which may be positioned by corresponding geometrical selection where the finally processed blade has the least loads during the operation of the rotor. In this way, intermetallic phases occurring between the TiAl alloy and the diffusion barrier layer are noncritical in respect of their low ductility.

A successful heat treatment of the entire multilayer composite, if this has not already been carried out before the joining or construction of the individual components, requires matching of the transition temperatures in the individual material groups (in the case of TiAl, for example, by selection of the proportion of Al), in order to be able to heat-treat the composites (blade with diffusion barrier layer and block, or blade root) in a common oven anneal. The temperature range should in this case be selected in such a way that a homogeneous grain size distribution is set up, which ensures on the one hand an optimal creep strength in the blade body and on the other hand a high strength in the lower layer region at the junction with the disk.

The precipitation in the blade body may in principle also be carried out by anneals in the corresponding temperature range, after the entire set has been heat-treated.

1.-13. (canceled)

14. A method of making a bladed rotor for a turbomachine, wherein the method comprises making at least one blade by connecting a blade body to a blade root by a diffusion barrier layer, at least the blade body, the diffusion barrier layer and the blade root consisting of respectively different materials; and joining the blade root to a rotor base.

15. The method of claim 14, wherein the rotor base is made of a nickel-based alloy and/or of a titanium alloy.

16. The method of claim 15, wherein the titanium alloy comprises at least one of Ti64, Ti6242, Ti6246, or Ti834.

17. The method of claim 15, wherein the nickel-based alloy comprises at least one of DA 718, IN 718, AD 730, Waspaloy, or Udimet 720.

18. The method of claim 14, wherein the blade root consist at least in the region of its surface of the same material, or a material of the same type, as the rotor base and/or an upper side of the blade root is arranged in a lowest-load region of the blade.

19. The method of claim 14, wherein the blade root is joined to the rotor base with a material fit.

20. The method of claim 19, wherein the blade root is welded to the rotor base.

21. The method of claim 14, wherein the blade body is constructed additively on the diffusion barrier layer and/or the diffusion barrier layer is constructed additively on the blade root and/or is connected to the blade root by friction welding.

22. The method of claim 14, wherein the diffusion barrier layer is produced from a material which is compatible with a TiAl alloy.

23. The method of claim 22, wherein the diffusion barrier layer is produced from a CoTiAl alloy.

24. The method of claim 14, wherein the diffusion barrier layer is produced with a layer thickness of at least 1 mm and/or at most 50 mm.

25. The method of claim 14, wherein blade body is provided together with a root strip.

26. The method of claim 14, wherein the blade body is made of a TiAl alloy.

27. The method of claim 26, wherein the blade body is made of a TiAl alloy which in addition to Ti and Al comprises at least one of W, Mo, Nb, Co, Hf, Y, Zr, Er, Gd, Si, and C.

28. The method of claim 14, wherein at least the blade body is constructed by an additive production method.

29. The method of claim 28, wherein the additive production method is selected from at least one of selective laser melting, selective laser sintering, electron-beam melting, laser deposition welding.

30. The method of claim 14, wherein at least the blade body is constructed by friction welding and/or by hot isostatic pressing of a capsule filled with a material powder.

31. The method of claim 14, wherein the rotor base and/or the blade root and/or the diffusion barrier layer and/or the blade body is or are heat-treated individually or in any combination before and/or during and/or after joining the blade root to the rotor base.

32. A bladed rotor for a turbomachine, wherein the bladed rotor comprises a rotor base and at least one blade connected to the rotor base, which blade comprises in radial direction at least a blade root joined to the rotor base, a diffusion barrier layer and a blade body, and wherein at least the blade body, the diffusion barrier layer and the rotor base respectively consist of different materials.

33. A turbomachine, wherein the turbomachine comprises the bladed rotor of claim 32.
